(19) United States
(12) Patent Application Publication
(10) Pub. No.: US 2016/0273083 A1
(43) Pub. Date: Sep. 22, 2016

(54) WELDING MATERIAL FOR SUBMERGED ARC WELDING AND GAS METAL ARC WELDING, HAVING REMARKABLE IMPACT RESISTANCE AND ABRASION RESISTANCE

(71) Applicant: POSCO, Pohang-si, Gyeongsangbuk-do (KR)

(72) Inventors: Bong-Keun LEE, Pohang-si (KR); Il-Wook HAN, Pohang-si (KR); Jeong-Kil KIM, Pohang-si (KR); Sang-Chul LEE, Pohang-si (KR); Dong-Ryeol LEE, Pohang-si (KR); Geug KIM, Pohang-si (KR)

(21) Appl. No.: 15/035,036

(22) PCT Filed: Sep. 24, 2014
(86) PCT No.: PCT/KR2014/008891

§ 371 Date: May 6, 2016

(30) Foreign Application Priority Data
Dec. 6, 2013 (KR) 10-2013-0151811

(51) Int. Cl. C22C 38/58; B23K 35/30; C22C 38/42; C22C 38/38; C22C 38/32; B23K 9/173; C22C 38/24; C22C 38/22; C22C 38/02; C22C 38/00; B23K 9/18; B23K 35/02; C22C 38/26

(52) U.S. Cl. CPC C22C 38/58; B23K 35/0255; B23K 35/3073; C22C 38/42; C22C 38/38; C22C 38/32; C22C 38/26; C22C 38/24; C22C 38/22; C22C 38/02; C22C 38/002; C22C 38/001; B23K 9/18; B23K 9/173

(57) ABSTRACT

Provided is a welding material for submerged arc welding and gas metal arc welding, having remarkable impact resistance and abrasion resistance. The welding material for submerged arc welding and gas metal arc welding, having remarkable impact resistance and abrasion resistance, comprises: 0.12-0.75 wt % of C; 0.2-1.2 wt % of Si; 15-27 wt % of Mn; 2-7 wt % of Cr; 0.025 wt % or less of S; 0.020 wt % or less of P; and the balance of Fe and other inevitable impurities. Provided are a welding joint having remarkable weldability, low temperature impact toughness and abrasion resistance, and a welding material for submerged arc welding and gas metal arc welding very preferably applied to the manufacture of pipes used in the oil sand industry field and the like.

### TECHNICAL FIELD

The present disclosure relates to a welding material having high impact resistance and abrasion resistance for submerged arc welding and gas metal arc welding.

### BACKGROUND ART

Recent high oil prices have increased interest in methods of producing oil at low cost. Accordingly, techniques for separating crude oil in massive amounts have been developed, and there is increasing interest in the oil sands industry. The term “oil sands” was originally used to refer to sand or sandstone containing crude oil and is now used to refer to all kinds of rock, such as sedimentary rock, that exist in oil reservoirs and contain crude oil. Oil production methods of extracting crude oil from oil sands are relatively new methods of producing oil as compared to existing oil production methods of extracting crude oil from oil wells, and are expected to undergo further development to reduce production costs.

However, oil sands generally contain large amounts of impurities together with crude oil. Therefore, an impurity removing process is performed when extracting crude oil from oil sands. After mining oil sands, the oil sands are transferred a certain distance to separation equipment so as to extract crude oil from the oil sands, and then separation pipes are used to separate impurities and crude oil from the oil sands. In the separation pipes, crude oil and impurities (such as rocks, gravel, and sand) are rotated using water to collect the crude oil floating on the water. Basically, such pipes are required to have a high degree of strength. In addition, such pipes are required to have impact resistance and abrasion resistance because rock and gravel contained in the pipes impact the internal surfaces of the pipes, and in addition to impact toughness are required to be able to withstand low-temperature environments, for example, environments in which the temperature may fall to −29° C. Particularly, weld joints are strictly required to have such properties because weld joins are weaker than base metals. The physical properties of base metals may be adjusted through processes such as heat treatment processes, rolling processes, or controlled cooling processes so that the base metals may have the highest abrasion resistance and impact toughness obtainable from the compositions of the base metals. However, weld joints are mainly formed of welding materials and have internal structures similar to those formed in a casting process. Thus, it may be difficult to impart desired physical properties to weld joints.

Currently, pipes widely used for mining oil sands are API X65 grade pipes, X70 grade pipes, or the like. Seam welding is performed to manufacture such pipes, and welding materials for tack welding are used in such seam welding processes.

### DISCLOSURE

### Technical Problem

An aspect of the present disclosure may provide a welding material having a high degree of weldability, usable in submerged arc welding and gas metal arc welding to form weld joints having high degrees of low-temperature impact toughness and abrasion resistance.

### Technical Solution

According to an aspect of the present disclosure, a welding material may have high impact resistance and abrasion resistance for submerged arc welding and gas metal arc welding, and the welding material may include, by wt %, carbon (C): 0.12% to 0.75%, silicon (Si): 0.2% to 1.2%, manganese (Mn): 15% to 27%, chromium (Cr): 2% to 7%, sulfur (S): 0.025% or less, phosphorus (P): 0.020% or less, and a balance of iron (Fe) and inevitable impurities.

### Advantageous Effects

Embodiments of the present disclosure provide a welding material usable in submerged arc welding and gas metal arc welding to form weld joints having a high degree of weldability, a high degree of low-temperature impact toughness, and a high degree of abrasion resistance. Thus, the welding material may be usefully used to manufacture pipes in the oil sands industry or the like.

### BEST MODE

The inventors have conducted research into developing a welding material for forming weld joints having high degrees of low-temperature impact toughness and abrasion resistance in a process of welding high-manganese oil sand separation pipes designed to extract crude oil from oil sands. During the research, the inventors have found that if alloying elements of a welding material are properly adjusted, high weldability and the above-mentioned properties can be guaranteed, and have also found that welding materials suitable for tack welding in a pipe seam welding process are those for submerged arc welding and gas metal arc welding. Based on this knowledge, the inventors have invented the present invention.

The contents of alloying elements will now be described according to an exemplary embodiment of the present disclosure. Welding materials for submerged arc welding and welding materials for gas metal arc welding may be different in diameter but may have the same composition.

Therefore, the scope of the present invention encompasses these two kinds of welding materials as long as the welding materials have the composition described below.

C: 0.12 wt % to 0.75 wt %

Carbon (C) is a powerful element effective in stabilizing austenite and thus guaranteeing the strength and low-temperature impact toughness of weld metals. If the content of carbon (C) is less than 0.12 wt %, austenite may not be formed, leading to poor toughness. Conversely, if the content of carbon (C) is greater than 0.75 wt %, gases such as carbon dioxide gas may be generated during a welding process to cause defects in weld joints, and carbon (C) may combine with alloying elements such as manganese (Mn) or chromium (Cr) and may form carbides such as MC or M₂₃C₆ to cause a decrease in low-temperature impact toughness. Therefore, it may be preferable that the content of carbon (C) be within the range of 0.12 wt % to 0.75 wt %.

Si: 0.2 wt % to 1.2 wt %

Silicon (Si) is added to remove oxygen from weld metal. IF the content of silicon (Si) is less than 0.2 wt %, the deoxidizing effect is insufficient, and weld metal may have low fluidity. Conversely, if the content of silicon (Si) is greater than 1.2 wt %, segregation may occur in weld metals, thereby causing a decrease in low-temperature impact toughness and having a negative effect on weld crack sensitivity. Therefore, it may be preferable that the content of silicon (Si) be within the range of 0.2 wt % to 1.2 wt %.

Mn: 15 wt % to 27 wt %

Manganese (Mn) increases work hardening and guarantees stable formation of austenite even at a low temperature. Thus, the addition of manganese (Mn) may be needed. In addition, manganese (Mn) forms carbides together with carbon (C) and functions as an austenite stabilizing element like nickel (Ni). If the content of manganese (Mn) is less than 15 wt %, austenite may not be sufficiently formed, and thus low-temperature impact toughness may decrease. Conversely, if the content of manganese (Mn) is greater than 27 wt %, large amounts of fumes may be generated during welding, and abrasion resistance may decrease because slipping occurs instead of twining during plastic deformation. Therefore, it may be preferable that the content of silicon (Si) be within the range of 15 wt % to 27 wt %.

Cr: 2 wt % to 7 wt %

Chromium (Cr) is a ferrite stabilizing element, and the addition of chromium (Cr) enables decreases in the amounts of austenite stabilizing elements. In addition, chromium (Cr) facilitates the formation of carbides such as MC or M₂₃C₆. That is, if a certain amount of chromium (Cr) is added, precipitation hardening may be promoted, and the amounts of austenite stabilizing elements may be reduced. Thus, the addition of a certain amount of chromium (Cr) may be needed. In addition, since chromium (Cr) is a powerful anti-oxidation element, the addition of chromium (Cr) may increase resistance to oxidation in an oxygen atmosphere. If the content of chromium (Cr) is less than 2 wt %, the formation of carbides such as MC or M₂₃C₆ in weld joints may be suppressed, thereby decreasing abrasion resistance and increasing abrasion. Conversely, if the content of chromium (Cr) is greater than 7 wt %, manufacturing costs may increase, and abrasion resistance may steeply decrease. Therefore, it may be preferable that the content of chromium (Cr) be within the range of 2 wt % to 7 wt %.

S: 0.025 wt % or less

Sulfur (S) is an impurity causing high-temperature cracking together with phosphorus (P), and thus it may be preferable that the content of sulfur (S) be adjusted to be as low as possible. Particularly, if the content of sulfur (S) is greater than 0.025 wt %, compounds having a low melting point such as FeS are formed, and thus high-temperature cracking may be induced. Therefore, preferably, the content of sulfur (S) may be adjusted to 0.01 wt % or less, so as to prevent high-temperature cracking.

P: 0.020 wt % or less

Phosphorous (P) is an impurity causing high-temperature cracking, and thus it may be preferable that the content of phosphorus (P) be adjusted to be as low as possible. Preferably, the content of phosphorus (P) may be adjusted to be 0.020 wt % or less, so as to prevent high-temperature cracking.

According to an exemplary embodiment of the present disclosure, a welding material for submerged arc welding and gas metal arc welding may include the above-described alloying elements and the balance of iron (Fe) and impurities inevitably added during manufacturing processes. Owing to the above-described alloying elements, the welding material of the exemplary embodiment may have intended weldability and may be used to form weld joints having high impact resistance and abrasion resistance. In addition to the above-described alloying elements, the welding material of the exemplary embodiment may further include the following alloying elements. In this case, the properties of the welding material may be further improved.

N: 0.5 wt % or less

Nitrogen (N) improves corrosion resistance and stabilizes austenite. That is, the addition of nitrogen (N) leads to an effect similar to the effect obtainable by the addition of carbon (C). Therefore, nitrogen (N) may be added as a substitute for carbon (C). In addition, nitrogen (N) may combine with other alloying elements and form nitrides which may particularly improve abrasion resistance. The above-described effects may be obtained even in the case that nitrogen (N) is only added in small amounts. If the content of nitrogen (N) is greater than 0.5 wt %, impact toughness may markedly decrease. Therefore, it may be preferable that the content of nitrogen (N) be 0.5 wt % or less.

Ni: 10 wt % or less

Nickel (Ni) forms austenite by solid-solution strengthening and thus improves low-temperature toughness. Nickel (Ni) increases the toughness of weld joints by facilitating the formation of austenite, and thus weld joints having high hardness may not undergo brittle fracturing. If the content of nickel (Ni) is greater than 10 wt %, although toughness may be markedly increased, abrasion resistance may be markedly decreased, because of an increase in stacking fault energy. In addition, since nickel (Ni) is expensive, the addition of a large amount of nickel (Ni) is not preferred in terms of economical considerations. Therefore, it may be preferable that the content of nickel (Ni) be within the range of 10 wt % or less.

V: 5 wt % or less

Vanadium (V) dissolves in steel and retards the transformation of ferrite and bainite, thereby promoting the formation of martensite. In addition, vanadium (V) promotes solid-solution strengthening and precipitation strengthening. However, the addition of an excessively large amount of vanadium (V) does not further increase the above-described effects but decreases toughness and weldability and increases manufacturing costs. Therefore, the content of vanadium (V) may preferably be 5 wt % or less.

Nb: 5 wt % or less

Niobium (Nb) may increase the strength of weld joints by precipitation strengthening. However, the addition of an excessively large amount of vanadium (V), as well as increasing manufacturing costs, may cause the formation of coarse precipitates and may thus decrease abrasion resistance. Thus, the content of niobium (Nb) may preferably be 5 wt % or less.

Mo: 7 wt % or less

Molybdenum (Mo) may increase the strength of weld joints by matrix solid-solution strengthening. Furthermore, like niobium (Nb) and vanadium (V), molybdenum (Mo) promotes precipitation strengthening. However, the addition of an excessively large amount of molybdenum (Mo) does not further increase the above-described effects but worsens toughness and weldability and increases steel manufacturing costs. Therefore, it may be preferable that the content of molybdenum (Mo) be within the range of 7 wt % or less.

W: 6 wt % or less

Tungsten (W) may increase the strength of weld joints by matrix solid-solution strengthening. Furthermore, like niobium (Nb), vanadium (V), and molybdenum (Mo), tungsten (W) promotes precipitation strengthening. However, the addition of an excessively large amount of tungsten (W) does not further increase the above-described effects but worsens toughness and weldability and increases steel manufacturing costs. Therefore, it may be preferable that the content of tungsten (W) be within the range of 6 wt % or less.

Cu: 2 wt % or less

Copper (Cu) promotes the formation of austenite and improves the strength of weld joints. However, if the content of copper (Cu) is greater than 2 wt %, blue embrittlement may occur, and price competiveness may decrease. Therefore, it may be preferable that the content of copper (Cu) be within the range of 2 wt % or less.

B: 0.01 wt %% or less

Even a small amount of boron (B) increases strength by sold-solution strengthening and thus improves abrasion resistance. However, if the content of boron (B) is greater than 0.01 wt %, impact toughness may markedly decrease. Thus, the content of boron (B) may preferably be 0.01 wt % or less.

The welding material described according to the exemplary embodiment may have a high degree of low-temperature impact toughness, for example, 27 J or greater at −29° C., in addition to having high weldability. Furthermore, the welding material may be used to form weld joints having a high degree of abrasion resistance, for example, an abrasion amount of 2 g or less in an abrasion test according to the American Society for Testing and Materials (ASTM) G65. For example, the welding material of the exemplary embodiment may be used in the oil sands industry in which the above-described properties of the welding material are useful.

### MODE FOR INVENTION

Hereinafter, embodiments of the present disclosure will be described more specifically through examples. However, the examples are for clearly explaining the embodiments of the present disclosure and are not intended to limit the scope of the present invention.

Welding materials having the compositions illustrated in Tables 1 and 2 were manufactured, and pipes were manufactured by welding Hadfield steel parts using the welding materials. The low-temperature impact toughness and abrasion resistance of weld joints of the pipes were measured as illustrated in Table 2. The abrasion resistance of the weld joints was evaluated by measuring degrees of abrasion after performing an abrasion test according to American Society for Testing and Materials (ASTM) G65. API-X70 steel generally used in the oil industry has an abrasion amount of 2.855 g.

TABLE 1

| | Composition (wt %) | | | | | | | |
|---|---|---|---|---|---|---|---|---|
| Nos. | C | Mn | Si | Cr | P | S | N | Ni |
| Inventive | 0.55 | 25 | 0.5 | 3 | 0.015 | 0.015 | — | — |
| Sample 1 | | | | | | | | |
| Inventive | 0.7 | 25 | 1.2 | 3 | 0.005 | 0.005 | — | — |
| Sample 2 | | | | | | | | |
| Inventive | 0.25 | 20 | 0.3 | 3 | 0.01 | 0.005 | — | 5 |
| Sample 3 | | | | | | | | |
| Inventive | 0.15 | 15 | 0.2 | 3 | 0.015 | 0.01 | — | 10 |
| Sample 4 | | | | | | | | |
| Inventive | 0.3 | 25 | 0.3 | 3 | 0.02 | 0.015 | — | — |
| Sample 5 | | | | | | | | |
| Inventive | 0.12 | 25 | 0.5 | 3 | 0.015 | 0.015 | 0.25 | — |
| Sample 6 | | | | | | | | |
| Inventive | 0.35 | 25 | 0.4 | 3 | 0.015 | 0.015 | — | — |
| Sample 7 | | | | | | | | |
| Inventive | 0.4 | 25 | 0.2 | 3 | 0.015 | 0.015 | — | — |
| Sample 8 | | | | | | | | |
| Inventive | 0.35 | 25 | 0.4 | 3 | 0.01 | 0.01 | — | — |
| Sample 9 | | | | | | | | |
| Inventive | 0.35 | 25 | 0.3 | 3 | 0.015 | 0.01 | — | — |
| Sample 10 | | | | | | | | |
| Inventive | 0.3 | 27 | 0.5 | 3 | 0.015 | 0.025 | — | — |
| Sample 11 | | | | | | | | |
| Inventive | 0.3 | 24 | 0.4 | 3 | 0.01 | 0.01 | — | — |
| Sample 12 | | | | | | | | |
| Inventive | 0.3 | 24 | 0.4 | 2 | 0.015 | 0.015 | — | — |
| Sample 13 | | | | | | | | |
| Inventive | 0.25 | 25 | 0.3 | 6 | 0.015 | 0.015 | — | — |
| Sample 14 | | | | | | | | |
| Inventive | 0.3 | 23 | 0.2 | 7 | 0.012 | 0.01 | 0.01 | — |
| Sample 15 | | | | | | | | |
| Comparative | 0.15 | 15 | 0.15 | 3 | 0.002 | 0.015 | — | 16 |
| Sample 1 | | | | | | | | |
| Comparative | 0.08 | 25 | 0.4 | 3 | 0.015 | 0.01 | — | — |
| Sample 2 | | | | | | | | |
| Comparative | 0.3 | 25 | 0.4 | 3 | 0.015 | 0.015 | — | — |
| Sample 3 | | | | | | | | |
| Comparative | 0.3 | 25 | 0.35 | 3 | 0.015 | 0.015 | — | — |
| Sample 4 | | | | | | | | |
| Comparative | 0.3 | 23 | 0.35 | 3 | 0.015 | 0.01 | — | — |
| Sample 5 | | | | | | | | |
| Comparative | 0.3 | 25 | 0.5 | 3 | 0.015 | 0.005 | — | — |
| Sample 6 | | | | | | | | |
| Comparative | 0.05 | 25 | 0.6 | 3 | 0.015 | 0.015 | 0.5 | — |
| Sample 7 | | | | | | | | |
| Comparative | 1.25 | 23 | 1.6 | 3 | 0.03 | 0.015 | — | — |
| Sample 8 | | | | | | | | |

TABLE 2

| | | | | | | | Properties | |
|---|---|---|---|---|---|---|---|---|
| | | | | | | | Impact | Abrasion |
| | Composition (wt %) | | | | | | toughness | amount |
| Nos. | V | Nb | Mo | W | Cu | B | (@−29° C.) | (g) |
| Inventive | — | — | — | — | — | — | 70 | 1.25 |
| Sample 1 | | | | | | | | |
| Inventive | — | — | — | — | — | — | 80 | 1.89 |
| Sample 2 | | | | | | | | |
| Inventive | — | — | — | — | 1.8 | — | 84 | 1.43 |
| Sample 3 | | | | | | | | |
| Inventive | — | — | — | — | — | — | 85 | 1.75 |
| Sample 4 | | | | | | | | |
| Inventive | — | — | — | — | — | — | 32 | 1.15 |
| Sample 5 | | | | | | | | |
| Inventive | — | — | — | — | — | 0.01 | 43 | 1.62 |
| Sample 6 | | | | | | | | |
| Inventive | 5 | — | — | — | — | — | 35 | 1.17 |
| Sample 7 | | | | | | | | |
| Inventive | — | 4 | — | — | — | — | 35 | 1.10 |
| Sample 8 | | | | | | | | |
| Inventive | — | — | 4 | — | — | — | 37 | 1.15 |
| Sample 9 | | | | | | | | |
| Inventive | — | — | 6.5 | — | — | — | 37 | 1.00 |
| Sample 10 | | | | | | | | |
| Inventive | — | — | — | 1.5 | — | — | 62 | 1.30 |
| Sample 11 | | | | | | | | |
| Inventive | — | — | — | 4 | — | — | 42 | 1.40 |
| Sample 12 | | | | | | | | |
| Inventive | — | — | — | — | — | — | 29 | 1.33 |
| Sample 13 | | | | | | | | |
| Inventive | — | — | — | — | — | — | 33 | 1.01 |
| Sample 14 | | | | | | | | |
| Inventive | — | — | — | — | — | — | 35 | 0.91 |
| Sample 15 | | | | | | | | |
| Comparative | — | — | — | — | 2.5 | — | 89 | 2.06 |
| Sample 1 | | | | | | | | |
| Comparative | — | — | — | — | — | — | 18 | 0.81 |
| Sample 2 | | | | | | | | |
| Comparative | 6.5 | — | — | — | — | — | 24 | 1.02 |
| Sample 3 | | | | | | | | |
| Comparative | — | 6.5 | — | — | — | — | 21 | 0.99 |
| Sample 4 | | | | | | | | |
| Comparative | — | — | 8.5 | — | — | — | 19 | 0.91 |
| Sample 5 | | | | | | | | |
| Comparative | — | — | — | 7.5 | — | — | 26 | 1.50 |
| Sample 6 | | | | | | | | |
| Comparative | — | — | — | — | — | 0.015 | — | |
| Sample 7 | | | | | | | | |
| Comparative | — | — | — | — | — | — | — | — |
| Sample 8 | | | | | | | | |

As illustrated in Tables 1 and 2 above, the weld joints formed of Inventive Samples 1 to 15 having compositions proposed in the exemplary embodiment of the present disclosure had a high degree of weldability and a very high degree of low-temperature impact toughness within the range of 27 J or greater at −29° C. In addition, the degrees of abrasion of the weld joints were 2 g or less. That is, the weld joints had high abrasion resistance compared to API-X70 steel of the related art.

However, Comparative Samples 1 to 6 not satisfying alloying element contents proposed in the exemplary embodiment of the present disclosure had low degrees of low-temperature impact toughness and abrasion resistance compared to the inventive samples. In the case of Comparative Samples 7 and 8, it was difficult to perform welding because of unstable arcs or excessive amounts of spatters, and thus low-temperature impact toughness and abrasion resistance could not be evaluated.

1. A welding material having high impact resistance and abrasion resistance for submerged arc welding and gas metal arc welding, the welding material comprising, by wt %, carbon (C): 0.12% to 0.75%, silicon (Si): 0.2% to 1.2%, manganese (Mn): 15% to 27%, chromium (Cr): 2% to 7%, sulfur (S): 0.025% or less, phosphorus (P): 0.020% or less, and a balance of iron (Fe) and inevitable impurities.

2. The welding material of claim 1, further comprising nitrogen (N) in an amount of 0.4% or less.

3. The welding material of claim 1, further comprising nickel (Ni) in an amount of 10% or less.

4. The welding material of claim 1, further comprising vanadium (V): 5% or less, niobium (Nb): 5% or less, molybdenum (Mo): 7% or less, and tungsten (W): 6% or less.

5. The welding material of claim 1, further comprising copper (Cu) in an amount of 2% or less.

6. The welding material of claim 1, further comprising boron (B) in an amount of 0.01% or less.
